(19) United States
(12) Patent Application Publication
(10) Pub. No.: US 2026/0270639 A1
(43) Pub. Date: Sep. 10, 2026

(54) SYSTEMS AND METHODS FOR CAPTURING AND RENDERING SPATIAL AUDIO DATA OF A GIVEN SPACE

(71) Applicant: Varjo Technologies Oy, Helsinki (FI)

(72) Inventors: Oliver Merilaid, Helsinki (FI); Mikko Ollila, Tampere (FI)

(73) Assignee: Varjo Technologies Oy, Helsinki (FI)

(21) Appl. No.: 19/074,634

(22) Filed: Mar. 10, 2025

(51) Int. Cl. H04S 7/00; H04N 13/111; H04N 13/128

(52) U.S. Cl. CPC H04S 7/303; H04N 13/111; H04N 13/128; H04S 2400/15

(57) ABSTRACT

A system for capturing and rendering spatial audio data of given space, system includes: device(s) that is arranged within given space; observer device; and central processing unit (CPU). The device(s) includes: first audio sensor(s); first spatial orientation sensor (SOS); and first location sensor (LS). Observer device includes: second SOS; and second LS. CPU is configured to: receive first spatial audio capture data (SACD) from first audio sensor(s), first pose data from first SOS, and first location data from first LS; receive second pose data from second SOS, and second location data from second LS; process first SACD to correct and align said first SACD to generate processed first SACD; generate observer-specific audio data; and stream observer-specific audio data(s) to observer device.

### TECHNICAL FIELD

The present disclosure relates to systems for capturing and rendering spatial audio data of given spaces. Moreover, the present disclosure relates to methods for capturing and rendering spatial audio data of given spaces.

### BACKGROUND

A growing demand for immersive virtual reality (VR), augmented reality (AR), and extended reality (XR) experiences has highlighted a need for accurately capturing and rendering spatial audio and visual data. Such technologies provide users with realistic six degrees of freedom (6DoF) environments, where the users can freely navigate and interact with their surroundings while experiencing synchronized audio and visual content. However, achieving such a level of immersion is technically challenging, particularly when capturing the spatial audio and visual data with an accuracy and fidelity required for dynamic environments.

Conventionally, the spatial audio and visual data have been primarily captured for three degrees of freedom (3DoF), with limited capability to accurately represent six degrees of freedom (6DoF). For example, the spatial audio data may be captured by using a microphone array, while the visual data may be captured using cameras, often in combination with Light Detection and Ranging (LiDAR) sensors or Time-of-Flight (ToF) sensors. However, for capturing the visual data, static images can provide satisfactory results in many use cases, but does lack a lot of information by being stationary in nature. Conversely, the spatial audio data, being inherently non-stationary by nature (i.e., such data changes over time), cannot be accurately captured without using multiple sensors distributed across a given space. Such limitations become even more pronounced when attempting to provide a seamless and immersive experience using a single XR device.

Conventionally, existing solutions for capturing the spatial audio and visual data for 6DoF applications often rely on stationary systems with distributed sensor arrays. For capturing the spatial audio data, existing solutions involve installing multiple stationary microphone arrays across an area (i.e., the area where spatial audio data is captured). However, such systems are expensive, require meticulous setup, and depend on advanced software for processing and rendering (for example, Zylia 6DoF solution may be used). Such systems can achieve satisfactory results, but are limited in scalability, lack portability, and require significant hardware investment, thereby making them impractical for certain use cases. Similarly, for capturing the visual data, traditional photogrammetry methods rely on devices (for example, such as Leica three-dimensional scanners), which rely on multiple sensors or scanning devices to generate three-dimensional (3D) point clouds. Although such an approach is effective, it is also static, resource-intensive, requires high processing power, and is often limited to predefined spaces, thereby restricting its applicability for dynamic and interactive environments. Moreover, lightweight solutions have emerged to address some of the aforesaid challenges. For example, such solutions may utilize mobile devices equipped with LiDAR and cameras for scanning. Such approaches leverage advanced techniques like 3D Gaussian splatting to create static photogrammetry models, but still lack the capability to dynamically capture and render the spatial audio and visual data for real-time 6DoF consumption.

Therefore, in light of the foregoing discussion, there exists a need to overcome the aforementioned drawbacks.

### SUMMARY

The aim of the present disclosure is to provide a system and a method for capturing and rendering spatial audio data of a given space to ensure accurate localization, synchronization, and adaptation of the spatial audio data in six degrees of freedom (6DoF) based on position and orientation of an observer, thereby enhancing spatial awareness, immersive experience, and real-time interaction within the given space. The aim of the present disclosure is achieved by a system and a method for capturing and rendering spatial audio data of a given space, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates a block diagram of a system for capturing and rendering spatial audio data of a given space, in accordance with an embodiment of the present disclosure;

FIG. 2 illustrates steps of a method for capturing and rendering spatial audio data of a given space, in accordance with an embodiment of the present disclosure; and

FIG. 3 illustrates an exemplary implementation of a system for capturing and rendering spatial audio data of a given space, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a system for capturing and rendering spatial audio data of a given space, the system comprising:
at least one device that is arranged within the given space, the at least one device comprising:
   at least one first audio sensor;
   a first spatial orientation sensor; and
   a first location sensor;
an observer device comprising:
   a second spatial orientation sensor; and
   a second location sensor; and
a central processing unit communicably coupled with the at least one device and the observer device, the central processing unit being configured to:
receive, from the at least one device, a first spatial audio capture data from the at least one first audio sensor, a first pose data from the first spatial orientation sensor, and a first location data from the first location sensor, wherein the first spatial audio capture data, the first pose data and the first location data are with respect to the given space;
receive, from the observer device, a second pose data from the second spatial orientation sensor, and a second location data from the second location sensor, wherein the second pose data and the second location data are with respect to a virtual space that corresponds to the given space;
process the first spatial audio capture data to correct and align said first spatial audio capture data to generate a processed first spatial audio capture data, based on the first pose data and the first location data;
generate an observer-specific audio data based on the processed first spatial audio capture data, the second location data, and the second pose data; and
stream at least the observer-specific audio data to the observer device.

In a second aspect, the present disclosure provides a method for capturing and rendering spatial audio data of a given space, the method comprising:
receiving, from at least one device, a first spatial audio capture data from at least one first audio sensor, a first pose data from a first spatial orientation sensor, and a first location data from a first location sensor, wherein the first spatial audio capture data, the first pose data and the first location data are with respect to the given space;
receiving, from an observer device, a second pose data from a second spatial orientation sensor, and a second location data from a second location sensor, wherein the second pose data and the second location data are with respect to a virtual space that corresponds to the given space;
processing the first spatial audio capture data to correct and align said first spatial audio capture data to generate a processed first spatial audio capture data, based on the first pose data and the first location data;
generating an observer-specific audio data based on the processed first spatial audio capture data, the second location data, and the second pose data; and
streaming at least the observer-specific audio data to the observer device.

The present disclosure provides the aforementioned first aspect and the aforementioned second aspect for capturing and rendering the spatial audio data of the given space. Herein, the use of the first pose data, the second pose data, the first location data, and the second location data from both the at least one device and the observer device ensures an accurate alignment and correction of the first spatial audio capture data. Moreover, correlation of the first spatial audio capture data and the first location data and the second location data between the given space and the virtual space provides a seamless integration. Such an approach ensures that audio sources in the virtual space are perceived as originating from an accurate spatial location within the given space, thereby enhancing engagement and immersion of a user. Additionally, by leveraging the first pose data and the first location data to correct and align the first spatial audio capture data, the system reduces artifacts and inconsistencies in the first spatial audio capture data.

Furthermore, it will be appreciated that generating the observer-specific audio data by processing the first spatial audio capture data ensures personalized audio rendering, wherein an audio dynamically adapts to perspective of the user. This customization significantly improves realism of an experience, particularly in applications like virtual reality (VR), augmented reality (AR), gaming, and similar. The system and the method support integrating data from multiple devices within the given space, each contributing the spatial audio capture data, the give pose data, and the given location data. This scalability allows the system and the method to accommodate complex environments, thereby providing comprehensive spatial audio coverage for large or multi-room spaces or similar. The system and the method are fast, robust, easy to implement, and facilitate accurate, real-time spatial audio rendering with high fidelity and adaptability across diverse applications and environments.

Throughout the present disclosure, the term “given space” refers to a defined physical environment or an area where the spatial audio data is being captured and rendered. The given space can be of any shape, size, or configuration and includes an indoor environment (for example, such as a room, a hall, and similar). In some environments with structural elements such as walls or partitions, additional spatial data may be required to accurately model acoustic behavior, ensuring that spatial audio rendering accounts for sound obstructions and reflections for a realistic auditory experience. Herein, the system is developed to address need for precise and immersive spatial audio rendering. It will be appreciated that by capturing and rendering the spatial audio data specific to the given space in six degrees of freedom (6DoF), the system improves an accuracy of audio localization and overall immersion. It will also be appreciated that such an approach enables an accurate spatial audio adaptation to translational and rotational movements of the user, ensuring a seamless and dynamic auditory experience that aligns with real-time positional changes.

Throughout the present disclosure, the at least one device is configured to capture, process, and transmit spatial audio data, spatial orientation data, and location data. The at least one device is positioned within boundaries of the given space, but the placement of the at least one device may be strategically configured within the boundaries of the given space. Such an arrangement ensures that the at least one device is capable of capturing the spatial audio data that accurately represents an acoustic environment of the given space. The arrangement of the at least one device is in such a manner, that said device can effectively sense the spatial audio data, spatial orientation data, and a location data within the given space, (i.e., free from obstructions that could compromise quality of data capturing). Herein, the term “audio sensor” refers to a device capable of detecting and capturing sound waves within the given space and converting them into electrical signals for further processing. The electrical signals comprises both analog and digital signals. Examples of the at least one audio sensor may include, but are not limited to, a microphone (such a directional microphone), a microphone array, and an ultrasonic microphone. The at least one audio sensor is configured to capture the first spatial audio capture data, wherein the first spatial audio capture data comprises a waveform data from which at least one of: an amplitude data, a frequency data, a phase data, can be derived using signal processing techniques such as Fast Fourier Transform (FFT), short-time Fourier transform (STFT), and similar, thereby enabling detection of position of a sound source and their characteristics within the given space.

The term “orientation sensor” refers to a device capable of measuring an angular position or an alignment of an object relative to a reference frame. Examples of the orientation sensor may include, but are not limited to, a gyroscope, an accelerometer, a magnetometer, and inertial measurement units (IMUs). The first spatial orientation sensor (i.e., a pose and orientation sensor) is configured to detect a pitch, a roll, and a yaw of the at least one device within the given space, thereby providing the first pose data that is essential for spatial alignment and correction of captured data. The term “location sensor” refers to a device capable of determining a physical position of an object within the given space. Examples of the location sensor may include, but are not limited to, Global Navigation Satellite System (GNSS) receiver, an ultrasonic sensor, ultra-wideband (UWB), and an infrared positioning system. Optionally, in an implementation, the camera can emulate/act as a location sensor. In some implementations, location tracking is achieved using a combination of sensors, such as IMU-assisted camera-based inside-out tracking, Steam VR lighthouse tracking, or other optical and non-optical tracking methods. IMUs alone cannot determine location but serve to assist other tracking means by providing motion data that enhances positional estimates. The first location sensor is configured to provide the first location data either in absolute terms (i.e., global coordinates) or in relative terms (i.e., distance from a reference point), thereby enabling an accurate mapping of a position of the at least one device within the given space. It will be appreciated that the system ensures that the spatial audio data being captured is accurately aligned with physical and spatial context of the given space. Such an arrangement reduces artifacts and inconsistencies, thereby enabling high-fidelity and immersive audio experiences, particularly in real-time applications such as VR, AR, gaming, and similar.

Optionally, a given device is any one of: stationary at a predefined position in the given space, non-stationary within the given space. In this regard, the term “predefined position” refers to a fixed, predetermined location in the given space where the given device is intentionally placed or mounted. Moreover, the term “stationary device” refers to a device that is fixed in a specific location and does not move or change position during operation within the given space. The stationary device is mounted securely at the predefined position within the given space, ensuring that its position remains constant throughout its operation. Examples of the stationary device may include, but are not limited to, devices mounted on walls, ceilings, and other fixed platforms. It will be appreciated that the given device being the stationary device provides consistent spatial data and reduces potential for variations in captured spatial audio and position data caused by movement, leading to more reliable and repeatable measurements. This is essential in environments where precise and steady data capture is necessary for an accurate processing and analysis, especially in spatial audio sensing and location tracking.

Moreover, the term “non-stationary device” refers to a device that is capable of movement within the given space during its operation. Unlike stationary devices, non-stationary devices are not fixed at a specific location and can move, either autonomously or by the user interaction, throughout the given space. Examples of the non-stationary device may include, but are not limited to, a handheld device, a mobile robot, a head-mounted display, and a drone. It will be appreciated that the given device being the non-stationary device offers greater flexibility and adaptability, allowing for dynamic interaction with the given space. This mobility enables the given device to cover larger areas or reach different points of interest that the stationary device cannot access. In an implementation, the given device encompasses the at least one device. Moreover, in some implementations, tracking means may be utilized to detect installation location during startup, eliminating the need for manual location configuration.

A technical effect of the given device being any one of: stationary at the predefined position in the given space, non-stationary within the given space is that it enables flexible and consistent capturing of the spatial audio data, allowing for both stable reference measurements in fixed locations and dynamic, real-time data acquisition from various positions within the given space. This adaptability enhances capability of the system to accurately capture and process the spatial audio data and position data under diverse operational conditions (i.e., such an approach increases accuracy of capturing the spatial audio data within the given space).

Optionally, the at least one device comprises at least one of: a head-mounted display (HMD) device, an extended-reality (XR) headset, a virtual reality headset, an augmented reality headset, a pair of XR glasses, a pair of smart Glasses, a tablet, a smart phone, a non-HMD device. In this regard, the term “head-mounted display device” refers to specialized equipment that is configured to present an extended reality (XR) environment to a user when said HMD, in operation, is worn by the user on their head. The HMD is implemented, for example, as an XR headset, a pair of XR glasses, and the like, that is operable to display a visual scene of the XR environment to the user. It will be appreciated that when the device is the HMD, it enables immersive user experiences by directly engaging in the user's field of view, allowing for seamless integration of virtual or augmented content with the physical world, improving interaction and immersion of the user. Moreover, the term “extended-reality headset” refers to a wearable device designed to immerse the user in the XR environment. The term “extended-reality” encompasses VR, AR, mixed reality (MR), and the like. Such glasses often incorporate transparent or semi-transparent lenses to overlay digital content onto a real world or provide a fully immersive view. Moreover, the term “virtual reality headset” refers to specialized device designed to provide fully immersive virtual environments by presenting a computer-generated world to the user. The VR headset consists of a display, motion sensors (such as accelerometers gyroscopes, and the like), input devices (such as controllers, and the like), and similar. When worn by the user, the VR headset entirely covers the user's field of vision, blocking out the real world and substituting it with a completely virtual scene. The VR headsets may also include auditory components, such as speakers or headphones, to provide three-dimensional (3D) audio for a fully immersive experience.

Moreover, the term “augmented reality headset” refers to a wearable device that overlays virtual content onto the user's view of the real world. The AR headsets may use transparent or semi-transparent lenses, cameras, and sensors to detect the real-world environment and ensure accurate positioning of digital content within it. The AR headsets are commonly used for applications like navigation, design, remote assistance, and similar. Moreover, the term “extended-reality glass” refers to a lightweight, wearable eyewear designed to display XR content. These glasses are typically equipped with transparent or semi-transparent lenses that allow digital content to be overlaid onto the real-world view. The pair of XR glasses are less immersive than full headsets but still provide a degree of interaction with the augmented or virtual environment. Moreover, the term “smart glass” refers to a wearable eyewear that incorporates advanced electronics to provide users with real-time information or augmented content. The pair of smart glasses may include displays, sensors, cameras, microphones, speakers, headphones, and similar, to support features such as notifications, navigation, fitness tracking, hands-free communication, and the like. Moreover, the term “tablet” refers to a portable computing device characterized by a flat, touchscreen interface and an absence of a physical keyboard. The tablet may also have built-in sensors, such as GPS, accelerometers, gyroscopes, and similar, that enable to capture the spatial audio data and interaction with augmented or virtual environments.

Moreover, the term “smart phone” refers to a portable communication device with computing capabilities that include a touch-sensitive display, a processor, storage, wireless communication features, and similar. Moreover, the term “non-head mounted device” refers to a device that is used to capture, process, or render the spatial audio and the visual data but does not involve a head-mounted display. The non-HMD device could include stationary or mobile devices such as desktop computers, laptops, tablets, or external audio capture systems. The non-HMD device may be used in scenarios where an immersive, HMD is not necessary but where the spatial audio data must still be captured and rendered effectively. The non-HMD device is used in situations where the user is interacting with an environment or a content on a larger screen or in a non-immersive, an external manner. The aforesaid types of the at least one device are well-known in the art.

A technical effect of the at least one device comprising the at least one of: the HMD device, the XR headset, the VR headset, the AR headset, the pair of XR glasses, the pair of smart Glasses, the tablet, the smart phone, the non-HMD device is that it enables the user to interact with and experience the XR environment by capturing, processing, and rendering both the spatial audio data and the visual data, thereby facilitating immersive, augmented, or virtual experiences in a manner adjusted to specific capabilities of the at least one device.

Optionally, the at least one first audio sensor comprises at least one of: a microphone array, an acoustic camera. In this regard, the term “microphone” refers to an electronic device designed to capture sound waves from the given space and convert them into electrical signals. The microphone array comprises multiple spatially distributed microphones that work collectively to capture the sound signals from various directions within the environment. It will be appreciated that the microphone array allows for real-time capture of the spatial audio data, thereby enhancing ability of the system to interact with both physical and virtual environments. This enables more immersive user experiences, such as spatial audio feedback, voice recognition, interaction with virtual objects via sound, and similar. Moreover, the term “acoustic camera” refers to a device that integrates an array of microphones with signal processing algorithms to capture, visualize, and localize sound sources within the given space. The acoustic camera is used for tasks such as identifying noise sources, sound field visualization, and detailed acoustic analysis in environments like industrial plants, automotive testing, architectural acoustics, and similar. It will be appreciated that the use of the acoustic camera provides detailed sound localization, which improves ability of the system to track dynamic sound sources and interactions. This enhances the realism and interactivity of the XR environment by offering precise audio feedback that aligns with visual elements, thereby enabling precise user interactions and improving response of the virtual environment to real-time audio inputs. The principle operation of the aforesaid types of the at least one audio sensor is well-known in the art.

A technical effect of the at least one first audio sensor comprising at least one of: the microphone array, the acoustic camera, is that it enhances ability of the system to accurately capture and process the spatial audio data by providing versatile audio sensing capabilities. The microphone array offers a straightforward means of capturing sound characteristics, while the acoustic camera enables precise localization and visualization of sound sources, thereby improving an accuracy and quality of the spatial audio data and enabling effective rendering of the acoustic environment.

Throughout the present disclosure, the term “observer device” refers to a device configured to monitor and interact with spatial and environmental attributes of the given space. The observer device is equipped with sensors and components to detect, measure, and report data related to its position, orientation, and similar, within the given space. The observer device can act as a reference or an active participant within the system for tasks such as user interaction, real-time spatial tracking, and similar. Herein, the second spatial orientation sensor measures an angular position, tilt, and orientation of the observer device relative to a reference frame. The second location sensor determines a relative position of the observer device within the given space, aligning it with the virtual environment rather than an absolute physical location. In an implementation, the spatial audio data within the given space collected by the at least one device is to be rendered on the observer device via the central processing unit.

Optionally, the observer device comprises at least one of: a head-mounted display (HMD) device, an extended-reality (XR) headset, a virtual reality headset, an augmented reality headset, a pair of XR glasses, a non-HMD device. In this regard, including various types of the observer device ensures that the system can adapt to different user environments and applications, whether immersive or non-immersive. It will be appreciated that the observer device being the HMD device enables immersive visualization and interaction with the system, enabling the users to experience detailed spatial awareness and real-time feedback. This enhances precision in applications requiring immersive engagement, such as training simulations, gaming environments, and similar. Moreover, it will be appreciated that the observer device being the XR headset provides a seamless blend of real and virtual environments, enabling the users to interact with both virtual objects and physical surroundings. Furthermore, it will be appreciated that the observer device being the VR headset facilitates a fully immersive experience by isolating the user from the physical environment, making it particularly useful for applications such as virtual prototyping, simulations, entertainment where complete immersion is essential, and similar. Furthermore, it will be appreciated that the observer device being the AR headset overlays virtual information onto the real-world environment, enhancing the user's situational awareness and enabling practical use in fields such as remote assistance, and similar. Furthermore, it will be appreciated that the observer device being the pair of XR glasses offers lightweight and wearable functionality, providing convenience for prolonged use while enabling natural interaction with augmented or mixed-reality elements. This makes the observer device suitable for everyday tasks requiring hands-free operation, such as on-site data visualization, and similar. Furthermore, it will be appreciated that the observer device being the non-HMD device (such as a smartphone, tablet, and similar) provides a portable and easily accessible option for monitoring or interacting with the system. This configuration is ideal for the users who prefer minimal equipment while retaining system functionality for applications like remote control or environmental analysis. Optionally, the observer device comprises a mobile device with an audio headset. The observer device may determine its location and orientation through various methods, including sensor-based tracking (e.g., IMU-based head tracking in headphones), manual input, or a combination of both (e.g., manually inputted location with orientation tracking from headset sensors). This flexibility ensures that the system can adapt to different user environments and applications, whether immersive or non-immersive. A technical effect of the observer device comprising the aforesaid devices is that it provides versatility in system interaction and functionality, enabling immersive, augmented, and portable experiences adjusted to specific requirements of various applications, such as training, visualization, remote operations, and similar.

Throughout the present disclosure, the term “central processing unit” refers to an electronic component or a processing unit configured to perform computational operations and data processing tasks within the system. The central processing unit executes predefined algorithms to enable functionality of the system, such as data fusion, spatial mapping, control of other connected components, and similar. In an implementation, the central processing unit gathers data from the at least one device and processes said data to be rendered on the observer device, wherein certain processing tasks may alternatively be performed on the observer device. For example, the spatial audio data may be processed in the central processing unit, but rotation tracking may be processed locally on the observer device.

Throughout the present disclosure, the term “first spatial audio capture data” refers to audio information captured by the at least one first audio sensor, representing sound characteristics such as a frequency, an amplitude, and directionality within the given space. The first spatial audio capture data is used to localize sound sources, analyse sound environments, generate spatial audio effects, and similar, based on the position and orientation of the at least one device. The term “first pose data” refers to a data that represents the spatial orientation of the at least one device in the given space. The first pose data includes information such as angular positioning, tilt, rotation, and alignment, which are captured by the first spatial orientation sensor. The term “first location data” refers to a data that represents the position of the at least one device within the given space. The first location data comprises coordinates or relative positioning information captured by the first location sensor. The first location data is essential for determining physical location of the at least one device within the given space and its relation to other devices or reference points. Herein, the central processing unit being communicably coupled to the at least one device, enables to receive the aforesaid data inputs from the at least one device. The integration of the aforesaid data types allows the central processing unit to interpret and process spatial audio, orientation, and positional data of the at least one device with respect to the given space, enabling functionalities such as spatial mapping, real-time interaction, environmental analysis, and similar.

Optionally, the central processing unit is configured to receive the first spatial audio capture data and the first location data from an existing stationary spatial audio capture system positioned within the given space. Herein, the term “existing stationary spatial audio capture system” refers to a pre-established, fixed audio capture setup that is positioned at a defined location within the given space. A technical effect of the central processing unit receiving the first spatial audio capture data, the first pose data, and the first location data is that it enables the system to create an accurate and dynamic spatial mapping of the given space, thereby facilitating real-time sound localization, enhanced user interaction, and immersive experiences by aligning spatial audio with positional and orientation data. Such an approach enhances ability of the system to adapt to user or environmental changes efficiently.

Throughout the present disclosure, the term “second pose data” refers to an information that describes an orientation or a rotation of the observer device in the given space. The second pose data is provided by the second spatial orientation sensor and represents how the observer device is positioned in terms of rotational angles relative to a reference frame, usually in 3D space. The second pose data specifically pertains to the orientation of the observer device in relation to the virtual space that corresponds to the given space. The term “second location data” refers to an information that provides positional coordinates of the observer device within the given space, as tracked by the second location sensor. The second location data is often represented in a cartesian coordinate system (i.e., x, y, z) or in other spatial coordinate systems. The second location data is used to determine the position of the observer device within the virtual space that corresponds to a real-world given space. The term “virtual space” refers to a computer-generated environment or coordinate system that simulates real-world space or represents an abstract digital space. The virtual space (i.e., a virtual version of the given space) is a model of spatial relationships in a digital format, designed to represent the given space in which objects, users, devices, or similar, can interact. The virtual space may be displayed through the XR devices and allows for user interactions with digital elements that are mapped to correspond to real-world positions or actions. Herein, the central processing unit being communicably coupled to the observer device receives the second pose data and the second location data. In this regard, once the central processing unit receives the second pose data and the second location data, the central processing unit is configured to process the second pose data and the second location data to map the pose and location of the observer device from a real space into the virtual space. This allows the system to maintain consistency between the real-world position of the observer device and corresponding virtual world coordinates, ensuring that the user's interactions and viewpoint are correctly represented in the virtual space.

A technical effect of the central processing unit receiving the second pose data and the second location data is that it enables accurate tracking of movement and orientation of the observer device within the virtual space. This synchronization between the real space and the virtual space allows for precise adjustments in rendering, providing a seamless and immersive experience where virtual objects and sound correspond correctly to the user's physical position and movements.

Throughout the present disclosure, the central processing unit uses the first pose data and the first location data to perform necessary adjustments on the first spatial audio data. This may involve applying algorithms to rotate, shift, or modify the captured audio data, ensuring said data aligns properly with actual spatial parameters of the at least one device in the given space. Herein, the central processing unit may apply algorithms to align the first spatial audio capture data to a consistent reference frame based on the first pose data and the first location data. This may involve compensating for factors like misalignment, distortion, inaccuracies, or similar, due to sensor placement, such as ensuring that directional cues (like sound localization, volume attenuation, and similar) are consistent with the real-world spatial arrangement. Additionally, the central processing unit may filter and process audio signals to compensate for any potential errors introduced by the sensor's position or movement within the given space. After applying these adjustments, the central processing unit generates the processed first spatial audio capture data, which is corrected and aligned spatially based on the location and pose information. The processed first spatial audio capture data is now more accurate representation of original sound sources relative to the first audio sensor, ensuring proper spatial audio characteristics like sound directionality and volume attenuation (i.e., gradual reduction in sound intensity with distance) are preserved in the observer-specific audio data. A technical effect of such an approach is that the first spatial audio capture data is accurately reflected in the virtual space, corresponding to its real-world counterparts. This enhances overall quality of spatial audio experience, ensuring that the processed first spatial audio capture data is positioned correctly relative to the user's or device's position and orientation. The result is an improved audio-visual interaction, where the processed first spatial audio capture data is in precise alignment with the user's real or virtual movement, thereby providing a more immersive and realistic experience in XR applications.

Throughout the present disclosure, the term “observer-specific audio data” refers to audio data that is dynamically generated or modified based on the processed first spatial audio capture data, the second location data, and the second pose data. The observer-specific audio data comprises spatial audio principles, such as sound localization, volume attenuation, directional cues, and similar, to simulate how the audio would naturally reach an ears of an observer associated with the observer device, ensuring an immersive and realistic auditory experience that corresponds to the observer's viewpoint in the environment. The observer-specific audio data is adjusted to reflect how the observer perceives the audio in relation to their location and movement within the given space. Herein, the central processing unit takes the processed first spatial audio capture data, which has already been corrected and aligned with respect to the given space, and uses the second location data and the second pose data. In this regard, the central processing unit is configured to process these inputs together to generate the observer-specific audio data that reflects the observer's viewpoint. This may involve calculating relative position and orientation between audio sources (i.e., real or virtual) and the observer to modify attributes such as volume, pitch, sound localization, and the like. By applying algorithms or other spatial audio techniques, the central processing unit adjusts how the audio is heard by the observer. It will be appreciated that such an approach enhances spatial accuracy of audio experience, ensuring that the audio appears to generate from correct direction and distance relative to the observer, thereby creating a more immersive and realistic audio-visual experience in XR applications. Moreover, the central processing unit is configured to integrate multiple spatially distributed three degrees of freedom (3DoF) audio captures to generate a six degrees of freedom (6DoF) audio representation. The resulting data may be stored in a spatial format for subsequent use or rendered in real-time for the observer. During real-time rendering, the system dynamically adjusts the audio output based on the observer's position and orientation, ensuring an accurate and immersive spatial audio experience.

The central processing unit streams observer-specific audio data to the observer device, once said observer-specific audio data has been generated. The streaming can happen in real-time, with the observer device receiving continuous updates on audio data as the observer moves and interacts within the given space. The streaming process involves sending the observer-specific audio data through an appropriate communication channels (for example, wireless communication channel or wired communication channel) to the observer device. Herein, the observer-specific audio data is continuously updated to reflect any changes in the observer's position and orientation in real-time. It will be appreciated that streaming the observer-specific audio data in real-time ensures that the observer-specific audio data remains spatially accurate and synchronized with the observer's actions, thereby enhancing realism and immersion of an auditory experience. It will also be appreciated that continuous updates to the observer-specific audio data reflect dynamic changes in the observer's position and orientation, ensuring that audio experience adapts instantaneously to the observer's movements, thereby improving an interactivity of the system in XR applications.

Optionally, the at least one device comprises at least two devices, when processing the first spatial audio capture data to correct and align said first spatial audio capture data, the central processing unit is further configured to:
receive first spatial audio capture data from the at least one audio sensor of each of the at least one two devices; and
perform audio stitching between each first spatial audio capture data received from the at least one audio sensor of each the at least one two devices.

In this regard, the term “audio stitching” refers to a process in which the first spatial audio capture data received from the at least one audio sensor of each the at least one two devices within the given space, are combined to form a unified, coherent spatial audio representation. In other words, the system comprises the at least two devices within the given space. Herein, the central processing unit is designed to establish communication channels with each of the at least one two devices. These devices are equipped with audio sensors that capture the first spatial audio data within the given space. The first spatial audio capture data received from said audio sensors includes spatial properties for example, such as amplitude, phase, directional characteristics of audio, and similar, at their respective positions. The central processing unit ensures synchronization of the first spatial audio capture data received from each of the at least one two devices. This synchronization involves aligning temporal characteristics of received data, which may be achieved using timestamps, clock synchronization protocols, or other time-alignment techniques. Herein, temporal alignment is essential to maintain spatial accuracy and coherence of a final stitched audio output data. Additionally, the central processing unit may apply preprocessing techniques to the first spatial audio capture data being received, for example, noise filtering technique (i.e., to remove background noise or other undesirable artifacts from the first spatial audio capture data), gain adjustment technique (to normalize variations in signal intensity between datasets, ensuring uniform output levels), normalization technique (to standardize dynamic range of the first spatial audio capture data for consistent quality), or similar. Such preprocessing techniques enhance the quality and consistency of the first spatial audio capture data before stitching. Once the preprocessing is complete, the central processing unit is configured to perform the audio stitching process by integrating the first spatial audio capture data from the at least one audio sensor of each of the at least one two devices. This integration considers spatial characteristics such as relative positions, orientations, and similar attributes of each of the at least one two devices in the given space. Herein, the stitching process may involve phase alignment (i.e., correcting phase mismatches between datasets to avoid distortions), redundancy elimination (i.e., removing overlapping or redundant data captured by multiple sensors), interpolation (i.e., filling in any missing or incomplete audio data), or similar.

Moreover, advanced algorithms may be used to merge the first spatial audio capture data into a unified spatial audio representation that accurately reflects sound environment in the given space. The final stitched audio data, representing the unified spatial audio environment, is then prepared for further processing and delivery to the observer device. It will be appreciated that synchronization of the first spatial audio capture data from the at least one audio sensor of each of the at least one two devices ensures temporal alignment, thereby preventing distortions and maintaining integrity of the spatial audio characteristics (e.g., amplitude, directionality, phase, and similar). Such an alignment is particularly essential in dynamic environments where audio sources or observer positions may change in real-time. It will also be appreciated that performing the process of audio stitching enables an accurate reconstruction of the acoustic environment within the given space, providing a highly realistic and immersive audio experience for the observer.

A technical effect of the aforementioned feature is that the central processing unit enables creation of unified and coherent spatial audio representation by seamlessly integrating the first spatial audio data from each of the at least one two devices. Such an approach ensures an accurate spatial audio rendering, enhanced audio quality, and real-time adaptability to changes in the acoustic environment, thereby improving user immersion and reliability of the system.

Optionally, the at least one device comprises at least two devices that are arranged at a first location and a second location, respectively, within the given space, when processing the first spatial audio capture data to correct and align said first spatial audio capture data, the central processing unit is further configured to:
apply interpolation to generate a first audio data for an area between the first location and the second location;
apply extrapolation to generate a second audio data for an area lying outside a predefined threshold range of the first location and/or the second location.

In this regard, the term “first location” refers to a specific position in the given space where a first device from amongst the at least two devices is situated. Moreover, the term “second location” refers to a specific position in the given space where a second device from amongst the at least two devices is situated. The first location and the second location serve as references for capturing the first spatial audio data that provides information about the spatial audio characteristics at that specific point within the given space. Moreover, the term “first audio data” refers to audio information captured by the first audio sensor for an area between the first location and the second location within the given space. Moreover, the term “second audio data” refers to audio information captured by the second audio sensor for the area lying outside predefined threshold range of the first location and/or the second location. The first audio data and the second audio data may include properties such as sound amplitude, a phase, a frequency, directionality, and similar, which are recorded at the first location of the first sensor. Moreover, the term “interpolation” refers to a technique that is used to generate the first audio data for the area between the first location and the second location by predicting values of the spatial audio characteristics at an intermediate points. Moreover, the term “extrapolation” refers to a technique that is used to generate the second audio data for the area lying outside the predefined threshold range of the first location and/or the second location. The predefined threshold range may encompass walls of a given room with the given space.

Herein, the central processing unit is configured to apply the interpolation to generate the first audio data for regions between these two locations. Based on the properties of the first audio data, the central processing unit uses an appropriate interpolation algorithm (for example, linear, spline, polynomial interpolation, or similar) to predict audio properties at intermediate points between the first location and the second location. Moreover, the central processing unit is configured to apply the interpolation when the observer is located within an area enclosed by the audio sensors and extrapolation when the observer is outside this area. These processes enable the system to estimate spatial audio properties at positions where direct sensor data is unavailable, ensuring a seamless and realistic auditory experience. The central processing unit estimates the first audio data at intermediate points by using known audio data from the first location and the second location. For example, the central processing unit may calculate an average or weighted sum of values of said data for the area between the first location and the second location. The interpolation ensures that generated audio data smoothly transitions from the first location to the second location, preserving continuity of the spatial audio characteristics over interpolated area. Once the interpolation process is completed, the central processing unit generates the first audio data that accurately represents the spatial audio characteristics for the area between the first location and the second location. Such audio data is a result of combining the properties of the first location and the second location with estimated data for intermediate points, producing a continuous, smooth, and coherent spatial audio experience. It will be appreciated that such an interpolation technique enhances continuity and smoothness of the audio characteristics across the given space, ensuring a more natural and immersive auditory experience for the observer.

Moreover, the central processing unit is configured to generate the second audio data by applying the extrapolation to estimate the spatial audio characteristics for the area lying outside the predefined threshold range of the first location and/or the second location. In this regard, the central processing unit uses known audio data from the first location and the second location as reference points, extending these values beyond the predefined threshold range to predict audio properties in the extrapolated area. In this regard, the central processing unit is configured to select an appropriate extrapolation technique (such as linear, polynomial extrapolation, or similar) to extend the audio characteristics by modelling the relationship between the audio data at the first location and the second location. For example, if there may be a consistent variation in amplitude or phase between the first location and the second location, the central processing unit may use this observed relationship to extend the spatial audio characteristics beyond the predefined threshold range. Specifically, the central processing unit extrapolates the values of amplitude, phase, or other spatial audio properties based on known data from the first location and second location. This extrapolation allows the central processing unit to estimate the spatial audio characteristics in the area lying outside the predefined threshold range, thereby ensuring that the second audio data being generated reflects a smooth transition and continuity in the spatial audio experience. It will be appreciated that by applying the extrapolation allows the system to provide audio data for regions outside of the predefined threshold range, which could enhance spatial audio coverage and ensure continuous auditory experience, even in areas where sensor data is unavailable.

A technical effect of the aforementioned feature is that it enables generation of continuous and coherent spatial audio data by accurately predicting the spatial audio characteristics for intermediate and extrapolated areas, thereby ensuring a seamless auditory experience across the given space.

Optionally, the observer device further comprises at least one processor that is configured to:
receive the observer-specific audio data;
process the observer-specific audio data to render the observer-specific audio data in a binaural format for spatial playback to a user associated with the observer device.

In this regard, the term “processor” refers to a computational element that is operable to execute the software framework. Examples of the processor may include, but are not limited to, a microprocessor, a microcontroller, a complex instruction set computing (CISC) microprocessor, a reduced instruction set computing (RISC) microprocessor, a very long instruction word (VLIW) microprocessor, digital signal processor (DSP), central processing unit (CPU), Field Programmable Gate Array (FPGA), or any other type of processing circuit. Moreover, the term “binaural format” refers to an audio representation designed to replicate a way audio is naturally heard by human ears, providing 3D audio experience. In this format, two audio channels (i.e., left and right) are used to simulate how audio would reach each ear from different directions and distances. The binaural format incorporates factors such as timing, intensity, and frequency modifications caused by a shape of an outer ear (i.e., pinna), head, and torso, which affect how audio is perceived from various spatial positions.

Herein, the at least one processor in the observer device receives the observer-specific audio data, which has been generated to reflect the user's position and orientation in the given space. The observer device may receive the observer-specific audio data that may be already encoded in the binaural format, or it may receive audio data encoded in a different format, such as a spatial format, and process said data to convert it into the binaural format. In this regard, to create the binaural format, the at least one processor processes the observer-specific audio data to simulate how sound would reach the user's ears. The at least one processor does this by applying algorithms that model the way sound waves are affected by the user's head position, ear shape, and an environment around them. The at least one processor is configured to process the observer-specific audio data either locally on the observer device (at an edge) or remotely on a local or cloud-based processor. Optionally, the at least one processor may apply Head-Related Transfer Function (HRTF) filters to the audio signals, which simulate the way sound is perceived by each ear, factoring in the directionality, and influence of anatomical structures such as head, torso, and outer ear (pinna). Once the observer-specific audio data is processed in the binaural format, the at least one processor renders the observer-specific audio data in the binaural format that can be played back to the user. Herein, the binaural format creates a sense of directionality and depth of the observer-specific audio data, allowing the user to perceive audio sources as being positioned accurately within the given space. It will be appreciated that rendering the observer-specific audio data in the binaural format enables a highly immersive and natural 3D audio experience, which enhances perception of spatial relationships between audio sources within the given space.

A technical effect of the aforementioned feature is that it enables the generation of personalized, immersive spatial audio experiences by processing the observer-specific audio data in the binaural format, ensuring an accurate localization and depth perception of audio for the user based on their specific position and orientation within the given space.

Optionally, the at least one device further comprising at least one first camera, wherein the central processing unit is further configured to:
receive, from the at least one device, at least one first image with respect to the given space, from the at least one first camera;
generate a photogrammetric model, based on the at least one first image data;
render a viewpoint image for the observer device, based on the photogrammetric model, the second location data, and the second pose data; and
stream the viewpoint image corresponding to the observer-specific audio data, to the observer device.

In this regard, the term “first image” refers to an image captured by the at least one first camera. The at least one first image represents the visual data of the given space from a particular viewpoint associated with the at least one device. The first image may include, but is not limited to, spatial, color, depth, and photometric information, depending on type of camera used, and serves as a primary visual reference for processing and integration with other data sources. Moreover, the term “photogrammetric model” refers to a 3D representation of the given space, constructed using image data captured from the at least one first camera. The photogrammetric model is generated through photogrammetry, a process that extracts depth, scale, and spatial relationships by analyzing multiple images taken from different viewpoints. The photogrammetric model could be point cloud which is then rendered using modern neural radiance field (NERF) techniques and gaussian splatting. The photogrammetric model could initially be a sparse point cloud, which can be enhanced and densified using modern neural radiance field (NeRF) techniques and Gaussian splatting. These techniques can infer finer granularity of viewpoints and accommodate larger viewpoint differences between two images, effectively enhancing spatial reconstruction. Moreover, the term “viewpoint image” refers to a rendered two-dimensional (2D) or 3D image that represents a specific visual perspective within the given space, corresponding to an observer's position and orientation. The viewpoint image is generated based on the photogrammetric model, spatial mapping data, and viewpoint-specific parameters (for example, the second location data and the second pose data of the observer device). The viewpoint image ensures that the visual representation accurately aligns with the observer's perspective, enhancing spatial coherence in AR, VR, remote visualization applications, or similar.

Herein, the at least one first camera captures the at least one first image with respect to the given space and sends said image to the central processing unit. The at least one first image may include details such as lighting, textures, objects, and their spatial relationships within the given space. The central processing unit processes the at least one first image to generate the photogrammetric model, which reconstructs the 3D structure of the given space based on image data. Using the photogrammetric model, along with the second location data and the second pose data, the central processing unit generates the viewpoint image. The viewpoint image is then streamed to the observer device, ensuring that the visual data aligns with the observer-specific audio data. This results in a synchronized experience where the observer perceives both audio and visuals from their designated viewpoint within the given space. It will be appreciated that generating the photogrammetric model from the at least one first image captured by the at least one first camera enables precise 3D reconstruction of the given space, allowing for accurate spatial representation without requiring depth sensors. It will also be appreciated that rendering the viewpoint image based on the photogrammetric model, ensures that the observer device receives a perspective-corrected visual representation, enhancing spatial coherence in AR, VR, and remote visualization applications. Furthermore, it will be appreciated that streaming the viewpoint image in synchronization with the observer-specific audio data provides an immersive and spatially accurate audiovisual experience, allowing the users to perceive audio and visuals from a unified viewpoint, which improves realism and situational awareness. A technical effect of the aforementioned feature is that the system provides a viewpoint-specific visual representation of the given space that dynamically aligns with the observer's position and orientation, ensuring an immersive and spatially accurate audiovisual experience.

Optionally, prior to rendering the viewpoint image for the observer device, the central processing unit is further configured to generate a three-dimensional (3D) representation, based on the at least one first image. In this regard, the at least one first camera captures the at least one first image with respect to the given space, which may include details such as lighting, textures, objects, and their spatial relationships within the given space. The central processing unit processes captured images to extract key spatial information (such as computer vision features), which may include detecting edges, shapes, and surfaces of objects in a given scene, as well as analysing lighting and depth cues in the at least one first image. Herein, the term “given scene” refers to an environment or a space being captured and represented by the system, which includes both visual information (such as textures, color, and the like) and spatial information (such as depth, 3D structure, and the like). The central processing unit may also identify and map features or points of interest in the at least one first image. To convert 2D image data into 3D information, the central processing unit uses algorithms to estimate depth and positioning of objects in the given space. This can be done by triangulation techniques (i.e., if multiple images are captured from different viewpoints), stereo vision (i.e., if there are multiple cameras), by applying machine learning-based depth estimation methods, or similar. Based on extracted depth and spatial information of the at least one first image, the central processing unit generates the 3D representation of the given space. This could be in the form of a point cloud, mesh model, volumetric representation, or similar. Once the 3D representation is created, the central processing unit can render the viewpoint image based on the user's specific location and orientation (i.e., from the second location data and the second pose data). The viewpoint image corresponds to what the user would see from their current viewpoint, ensuring an accurate spatial relationships and a consistent representation of the given space. It will be appreciated that generating the 3D representation from captured 2D images provides an accurate spatial reconstruction of the given space, ensuring precise mapping of objects and features for consistent viewpoint rendering. A technical effect of generating the 3D representation prior to rendering the viewpoint image is that it enhances spatial accuracy, reduces real-time processing complexity, and improves efficiency of viewpoint image generation. Such an approach results in a more immersive and synchronized user experience, particularly in AR, VR, remote visualization applications, and similar.

Optionally, the system further comprising any one: at least one second camera, at least one second audio sensor, arranged in the given space, wherein the at least one second camera and the at least one second audio sensor are stationary, wherein the at least one: the at least one second camera, the at least one second audio sensor, are communicably coupled with the central processing unit,

wherein the central processing unit is further configured to:
receive at least one second image from the at least one second camera, a second spatial audio capture data from the at least one second audio sensor; and
update the at least one first image and the first spatial audio capture data using the at least one second image and the second spatial audio capture data, respectively.

In this regard, the term “second image” refers to an image captured by the at least one second camera, which is positioned in a stationary manner within the given space. The at least one second image provides an additional visual reference that may be used for updating, correcting, or supplementing the at least one first image. The at least one second image may contribute to depth enhancement, feature matching, occlusion handling, or scene stabilization by providing a fixed-perspective viewpoint. Moreover, the term “second spatial audio capture data” refers to audio information captured by the at least one second audio sensor, which is arranged in a stationary manner within the given space. The second spatial audio capture data represents sound characteristics such as a frequency, an amplitude, and directionality from a fixed reference position. The second spatial audio capture data is used to enhance, validate, or update the first spatial audio capture data by providing a stable acoustic reference, improving audio source localization, environmental audio analysis, and spatial audio processing for accurate auditory representation within the given space.

Herein, the central processing unit being communicably coupled to the at least one second camera and the at least one second audio sensor, receives the at least one second image and the second spatial audio capture data from said devices. Upon receiving the at least one second image, the central processing unit processes said image to refine or enhance the at least one first image obtained from the at least one first camera. In this regard, such updating process may involve image fusion (i.e., combining data from the at least one first camera and the at least one second camera to fill occlusions or improve scene consistency), depth and perspective correction (i.e., using fixed perspective of the at least one second camera to rectify distortions or gaps caused by moving the at least one first camera), feature matching and enhancement (i.e., aligning shared image features between the at least one first image and the at least one second image to improve visual accuracy), optical flow (i.e., analyzing pixel motion between frames to estimate object movement and compensate for shifts), image alignment and warping (i.e., adjusting perspective and scaling to ensure seamless integration of multiple views), and similar. Similarly, the central processing unit also processes the second spatial audio capture data to refine the first spatial audio capture data. This may involve spatial audio refinement (i.e., using the second audio sensor's data to correct audio positioning discrepancies caused by a movement of the first audio sensor), noise reduction and signal enhancement (i.e., isolating relevant sounds using the stationary sensor as a reference to filter out unwanted background noise), time synchronization (i.e., aligning the audio signals captured from both sources to maintain temporal accuracy), and similar. After integrating the at least one second image and the second spatial audio capture data, the central processing unit updates the at least one first image and the first spatial audio capture data accordingly. The updated data is then used to provide an improved representation of the given space, ensuring accurate visual and auditory consistency for downstream processing or observer devices. It will be appreciated that leveraging stationary reference sensors allows for enhanced depth estimation, occlusion handling, and feature alignment, ensuring that the at least one first image maintains accuracy even in dynamic or complex environments. It will also be appreciated that the use of the second spatial audio capture data as a fixed reference enhances audio source localization, minimizes positional drift in spatial audio rendering, and enables more precise noise filtering, thereby improving auditory perception and immersion. Furthermore, it will be appreciated that integration of the at least one second image and the second spatial audio capture data enables improved spatial and temporal consistency in the visual and auditory representation of the given space, reducing inconsistencies caused by any sensor movement or environmental variations.

A technical effect of the aforementioned feature is that it improves the spatial and temporal consistency of the visual and auditory data by integrating inputs from the at least one second camera and the at least one second audio sensor which are stationary, leading to a more accurate and reliable representation of the given space. Such an approach reduces discrepancies caused by occlusions, motion artifacts, limited sensor coverage, or similar.

Optionally, the at least one first camera is implemented as at least one visible light camera. In this regard, the term “visible light camera” refers to an imaging device configured to capture electromagnetic radiation within visible spectrum, (i.e., ranging from 380 nanometers to 750 nanometers in wavelength). The at least one visible light camera utilizes optical lenses and an image sensor, such as a Complementary Metal-Oxide-Semiconductor (CMOS) or Charge-Coupled Device (CCD) sensor, to convert incoming light into digital image data. The captured image data represents a scene with natural color and brightness, making it suitable for applications such as photogrammetry, spatial mapping, AR, VR, remote visualization, and similar. Examples of a given visible light camera include, but are not limited to, a Red-Green-Blue-Depth (RGB), a monochrome camera. In an implementation, the at least one visible light camera captures images of the given space, which are then transmitted to the central processing unit. The central processing unit processes these images to construct the photogrammetric model, extracting depth and spatial information using structure-from-motion (SfM) or multi-view stereo (MVS) techniques. Based on this model, the central processing unit renders viewpoint images corresponding to the observer's position and orientation. The central processing unit then streams these viewpoint images to the observer device, ensuring an accurate visual representation aligned with the observer-specific audio data. A technical effect of the at least one first camera implemented as the at least one visible light camera is that high-resolution image data can be captured in natural color, enabling accurate photogrammetric modelling and spatial mapping. This enhances the precision of viewpoint image generation, improving alignment with the observer-specific audio data for an immersive AR, VR, or remote visualization experience.

Optionally, the at least one first camera is implemented as a combination of the at least one visible light camera and at least one depth camera. In this regard, the term “depth camera” refers to an imaging device that captures a distance information from a camera to each point in the given scene, typically producing grayscale intensity or phase-based images (e.g., multi-phase indirect time-of-flight (iTOF) imaging), rather than capturing color data. The at least one depth camera is used in applications like 3D scanning, AR, VR, robotics, and similar, to provide accurate spatial information for constructing 3D representation of the given space. Examples of the at least one depth camera may include, but are not limited to, a Red-Green-Blue-Depth (RGB-D) camera, a ranging camera, a Light Detection and Ranging (LiDAR) camera, a flash LiDAR camera, a Time-of-Flight (ToF) camera, a Sound Navigation and Ranging (SONAR) camera. Optionally, the at least one depth camera comprises a depth sensor, wherein the depth sensor is at least one of: a time-of-flight sensor, a LiDAR sensor. It will be appreciated that the at least one depth camera may provide depth information like RGB image data, per-pixel distance measurements, spatial geometry details, and similar, thereby enabling accurate reconstruction of the given scene and enhancing depth-aware rendering for AR/VR applications. A technical effect of implementing the at least one first camera as the combination of the at least one visible light camera and the at least one depth camera provides both high-resolution texture information and accurate depth data, resulting in a more precise and realistic 3D model of the given space. This fusion of data enhances spatial accuracy for rendering viewpoint images, improving the realism and immersion of the AR/VR experiences.

Optionally, when the at least one first camera is implemented as the combination of the at least one visible light camera and the at least one depth camera, the central processing unit is further configured to:
receive depth data from the at least one depth camera for each of the at least one first image;
process the depth data corresponding to the at least one first image for temporal and spatial alignment; and
fuse with or enhance the depth data with the photogrammetric model.

In this regard, the term “depth data” refers to an information that represents distance between the at least one depth camera and various objects within the given scene. The depth data provides spatial depth dimension, enabling the central processing unit to determine how far each point in the given scene is from the at least one depth camera. Such an information is essential for constructing 3D models and representations of the given space. The depth data can be represented in various formats, for example, such as depth maps (i.e., grayscale images where pixel intensity corresponds to distance), point clouds (i.e., collections of 3D points representing spatial coordinates), mesh models (which include depth data as part of a structured surface), or similar. The depth data is essential for applications requiring 3D spatial awareness, such as AR, VR, robotics, 3D scanning, and similar. Moreover, the term “temporal alignment” refers to a process of synchronizing data from the at least one visible light camera and the at least one depth camera in time, ensuring that said data corresponding to same moment or time frame is correctly matched and processed. In systems that capture data over time, such as video cameras or depth sensors, the temporal alignment is essential to align said data from multiple devices (i.e., from the at least one visible light camera and the at least one depth camera) to account for any discrepancies or delays in their data capture rates. The temporal alignment ensures that the data from the at least one visible light camera and the at least one depth camera is properly synchronized in time, facilitating an accurate analysis or fusion of said data. Moreover, the term “spatial alignment” refers to a process of aligning or registering data from the at least one visible light camera and the at least one depth camera in terms of their spatial positioning and orientation within the given space. The spatial alignment ensures that the data from the at least one visible light camera and the at least one depth camera is correctly mapped to same spatial frame of reference, enabling accurate integration of the data to form a cohesive representation of the given space.

In an implementation, the at least one visible light camera captures 2D image data, including textures, lighting, and colors of objects with respect to the given space. Such an information is essential for rendering realistic visual elements that will be displayed to the observer device. The at least one depth camera uses techniques such as stereo vision, structured light, or time-of-flight sensors to measure the distance between the at least one depth camera and objects in the given scene. The central processing unit first captures the depth data from the at least one depth camera for each of the images taken by the at least one visible light camera. In this regard, the central processing unit processes the depth data to ensure that the temporal alignment and the spatial alignment of the depth data correspond accurately to the at least one first image. The temporal alignment ensures that the depth data corresponds to exact moment the at least one first image was captured, which is important when dealing with moving objects or dynamic scenes. Similarly, the spatial alignment ensures that the depth data corresponds to correct objects and locations in captured image, preserving real-world distances and proportions. After the temporal alignment and the spatial alignment, the central processing unit fuses the depth data with the photogrammetric model. Such a fusion process combines the color and texture details from the at least one first image with the depth information, resulting in a more accurate and complete 3D model of the given space. This is done to refine a 3D point cloud data of the photogrammetric model and improve the overall accuracy of the model. It will be appreciated that by combining high texture and color details from the at least one visible light camera with spatial depth data from the at least one depth camera, the central processing unit can generate highly accurate, immersive, and realistic 3D representations of the given space. It will also be appreciated that such an approach ensures that objects and spatial relationships are represented accurately, even in complex or dynamic environments, thereby leading to a more natural and convincing visual interactions for the observer.

A technical effect of the aforementioned feature is that it enables an accurate integration of depth information with the visual data, thereby enhancing precision and realism of the 3D representation of the given scene. This results in improved spatial coherence and more immersive rendering of the viewpoint image for the observer device.

Optionally, the system further comprising a video-see-through (VST) camera, wherein the central processing unit is further configured to:
capture, using the VST camera, at least one VST image data of the given space from a given pose of the at least one device;
determine a temporal relationship between the at least one VST image data and the first spatial audio capture data;
adjust a timing of at least one of: the at least one VST image data, the first spatial audio capture data to at least one of: synchronise, time correct the at least one VST image data and the first spatial audio capture data with each other, based on the temporal relationship; and
outputting the at least one of the: at least one VST image data, the first spatial audio capture data, that has been adjusted, to the observer device.

In this regard, the term “video-see-through camera” refers to an imaging device used in MR and AR applications to capture real-time video footage of the given space while overlaying virtual content. The VST camera consists of one or more cameras that capture a scene from the user's perspective, and captured video is then processed and displayed on a display device, such as on the HMD, in a manner that allows the user to see both the real-world environment and computer-generated elements simultaneously. Herein, the VST camera is used to capture the at least one VST image data, which represents the visual data of the given space from a particular viewpoint (namely, a pose) of the at least one device within the given space. The VST camera enables the system to provide a live, transparent view of the given space, often used in mixed reality applications. In this regard, the temporal relationship between the at least one VST image data and the first spatial audio capture data is being determined. The temporal relationship refers to an alignment of the at least one VST image data and the first spatial audio capture data in time. For example, the central processing unit may calculate how much audio data is ahead or behind the visual data, based on when the first spatial audio capture data was captured relative to the at least one VST image data. Once the temporal relationship is determined, the central processing unit is configured to adjust the timing of at least one of: the at least one VST image data, the first spatial audio capture data to ensure synchronization. This may involve delaying or speeding up one or both types of data to achieve proper alignment. After the synchronization process, the adjusted data (i.e., the at least one VST image data, the first audio capture data, or both) is sent to the observer device, ensuring that the observer experiences both the audio and visual data with accurate timing, providing a cohesive and coherent mixed reality experience.

It will be appreciated that synchronizing the at least one VST image data with the first spatial audio capture data ensures a temporally consistent representation of the given space, reducing perceptual mismatches that could otherwise lead to misalignment between visual and auditory cues.

It will also be appreciated that by determining the temporal relationship and adjusting the timing accordingly, the system can dynamically compensate for processing delays, transmission latency, or differences in capture rates between the VST camera and the at least one device. Furthermore, it will be appreciated that the ability to align the at least one VST image data with the first spatial audio capture data enhances real-time interaction capabilities, which is particularly beneficial in applications such as remote collaboration, augmented reality navigation, training simulations, and similar.

A technical effect of the aforementioned feature is that it ensures precise temporal relationship between the at least one VST image data and the first spatial audio capture data, thereby enhancing coherence and realism of the mixed reality experience by minimizing perceptual discrepancies between the at least one VST image data and the first spatial audio capture data.

Optionally, the system further comprises a data repository communicably coupled to the central processing unit, wherein the data repository is configured to store thereat the second pose data and the second location data of the observer device. In this regard, the term “data repository” refers to hardware, software, firmware, or a combination of these for storing a given information in an organized (namely, structured) manner, thereby, allowing for easy storage, access (namely, retrieval), updating and analysis of the second pose data and the second location data of the observer device. The data repository may be implemented as a memory of the system, a removable memory, a cloud-based database, or similar. Optionally, the data repository can be implemented as one or more storage devices. In some implementations, the system may operate without an active observer, where data is captured and stored for offline processing and later use. This approach allows for post-processing of spatial data, enabling analysis, playback, or reconstruction of recorded environment without requiring real-time interaction. Such an implementation is beneficial in scenarios like research, forensic analysis, automated spatial mapping, and similar, where real-time observer input is unnecessary. Additionally, offline data processing can enhance accuracy by allowing for advanced filtering, error correction, and computationally intensive analysis that may not be feasible in real-time applications. A technical advantage of using the data repository is that it provides an ease of storage and access to processing the second pose data and the second location data of the observer device. It will be appreciated that storing the second pose data and the second location data of the observer device in the data repository enhances ability of the system to track and manage the observer's movement and position over time, providing an accurate and persistent reference for real-time adjustments. It will also be appreciated that maintaining a centralized data repository for the second pose data and the second location data facilitates efficient retrieval and analysis, enabling the central processing unit to quickly update and adapt to changes in the observer's position, thereby reducing latency and ensuring smoother transitions in presentation of virtual environment. Such an approach ensures that the central processing unit being communicably coupled to the data repository can provide an optimized and immersive experience in real-time, even as the observer moves within the given space.

The present disclosure also relates to the aforementioned second aspect as described above. Various embodiments and variants disclosed above, with respect to the aforementioned first aspect, apply mutatis mutandis to the aforementioned second aspect.

Optionally, when processing the first spatial audio capture data to correct and align said first spatial audio capture data, the method further comprising:
receiving first spatial audio capture data from the at least one audio sensor of each of at least one two devices; and
performing audio stitching between each first spatial audio capture data received from the at least one audio sensor of each the at least one two devices.

Optionally, when processing the first spatial audio capture data to correct and align said first spatial audio capture data, the method further comprising:
applying interpolation to generate a first audio data for an area between the first location and the second location;
applying extrapolation to generate a second audio data for an area lying outside a predefined threshold range of the first location and/or the second location.

Optionally, the at least one device further comprising at least one first camera, wherein the method further comprising:
receiving, from the at least one device, at least one first image with respect to the given space, from the at least one first camera;
generating a photogrammetric model, based on the at least one first image data;
rendering a viewpoint image for the observer device, based on the photogrammetric model, the second location data, and the second pose data; and
streaming the viewpoint image corresponding to the observer-specific audio data, to the observer device.

Optionally, when the at least one first camera is implemented as the combination of the at least one visible light camera and the at least one depth camera, the method further comprising:
receiving depth data from the at least one depth camera for each of the at least one first image;
processing the depth data corresponding to the at least one first image for temporal and spatial alignment; and
fusing with or enhancing the depth data with the photogrammetric model.

Optionally, the method further comprising:
capturing, using a video-see-through (VST) camera, at least one VST image data of the given space from a given pose of the at least one device;
determining a temporal relationship between the at least one VST image data and the first spatial audio capture data;
adjusting a timing of at least one of: the at least one VST image data, the first spatial audio capture data to at least one of: synchronise, time correct the at least one VST image data and the first spatial audio capture data with each other, based on the temporal relationship; and
outputting the at least one of the: at least one VST image data, the first spatial audio capture data, that has been adjusted, to the observer device.

Optionally, the method further comprising:
receiving at least one second image from at least one second camera, a second spatial audio capture data from at least one second audio sensor; and
updating the at least one first image and the first spatial audio capture data using the at least one second image and the second spatial audio capture data, respectively.

### DETAILED DESCRIPTION OF THE DRAWINGS

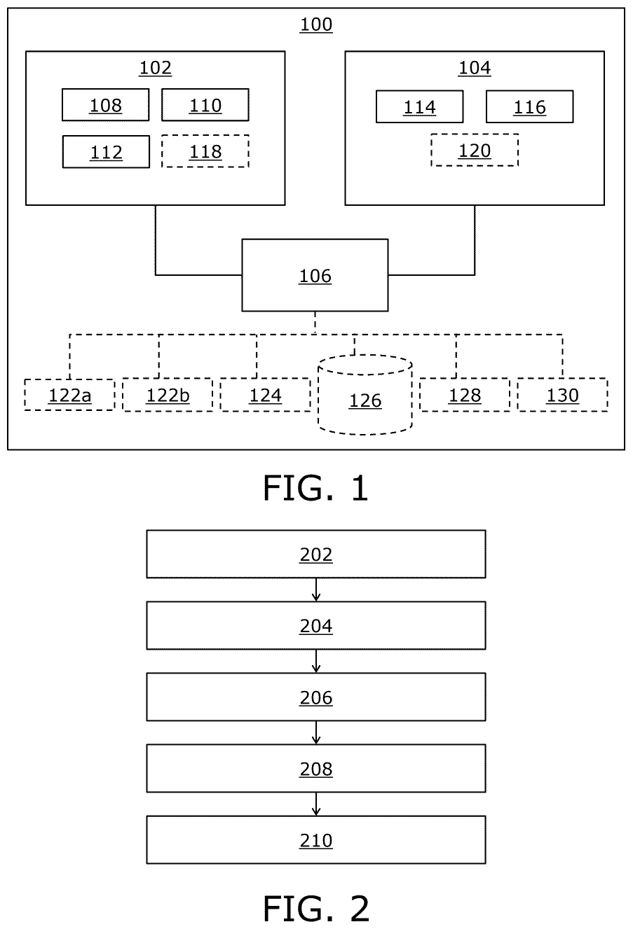

Referring to FIG. 1, illustrated is a block diagram of a system 100 for capturing and rendering spatial audio data of a given space, in accordance with an embodiment of the present disclosure. Herein, the system 100 comprises at least one device (depicted as a device 102) that is arranged in the given space, an observer device 104, and a central processing unit 106. The device 102 comprises at least one first audio sensor (for example, depicted as a first audio sensor 108), a first spatial orientation sensor 110, and a first location sensor 112. The observer device 104 comprises a second spatial orientation sensor 114 and a second location sensor 116. Herein, the central processing unit 106 is communicably coupled with the device 102 and the observer device 104. Herein, the first audio sensor 108 may be, for example, a microphone array. The central processing unit 106 is configured to perform various operations, as described earlier with respect to the aforementioned first aspect.

Optionally, the device 102 further comprises at least one first camera (for example, depicted as a first camera 118). Optionally, the observer device 104 further comprises at least one processor (depicted as a processor 120) that is configured to: receive observer-specific audio data; process the observer-specific audio data to render the observer-specific audio data in a binaural format for spatial playback to a user associated with the observer device 104. Optionally, the system 100 comprises at least two devices (depicted as devices 122a and 122b) that are arranged at a first location and a second location, respectively, within the given space, wherein said devices 122a-b are communicably coupled to the central processing unit 106. Optionally, the system 100 further comprises a video-see-through (VST) camera 124, a data repository 126, that are communicably coupled to the central processing unit 106. Optionally, the system 100 further comprises any one: at least one second camera (for example, depicted as a second camera 128), at least one second audio sensor (for example, depicted as a second audio sensor 130), arranged in the given space, wherein the second camera 128 and the second audio sensor 130 are stationary, wherein the at least one: the second camera 128, the second audio sensor 130, are communicably coupled with the central processing unit 106.

It may be understood by a person skilled in the art that the FIG. 1 includes a simplified architecture of a system 100 for sake of clarity, which should not unduly limit the scope of the claims herein. The person skilled in the art will recognize many variations, alternatives, and modifications of embodiments of the present disclosure.

Referring to FIG. 2, illustrated are steps of a method for capturing and rendering spatial audio data of a given space, in accordance with an embodiment of the present disclosure. At step 202, from at least one device, a first spatial audio capture data is received from at least one first audio sensor, a first pose data is received from a first spatial orientation sensor, and a first location data is received from a first location sensor, wherein the first spatial audio capture data, the first pose data, and the first location data are with respect to the given space. At step 204, from observer device, a second pose data is received from a second spatial orientation sensor, and a second location data is received from a second location sensor, wherein the second pose data and the second location data are with respect to a virtual space that corresponds to the given space. At step 206, the first spatial audio capture data is processed to correct and align said first spatial audio capture data to generate a processed first spatial audio capture data, based on the first pose data and the first location data. At step 208, an observer-specific audio data is generated based on the processed first spatial audio capture data, the second location data, and the second pose data. At step 210, at least the observer-specific audio data is streamed to the observer device.

The aforementioned steps are only illustrative and other alternatives can also be provided where one or more steps are added, one or more steps are removed, or one or more steps are provided in a different sequence without departing from the scope of the claims herein.

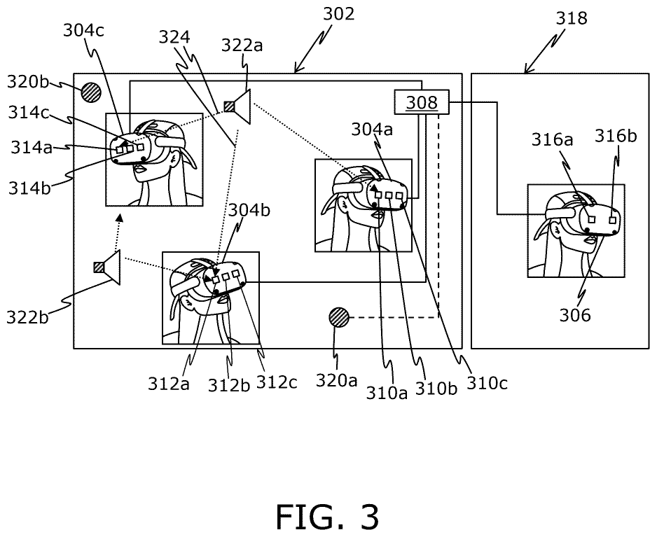

Referring to FIG. 3, illustrated is an exemplary implementation of a system for capturing and rendering spatial audio data of a given space 302, in accordance with an embodiment of the present disclosure. With reference to FIG. 3, the system comprises at least one device (for example, depicted as three devices 304a, 304b, and 304c) that is arranged in the given space 302, an observer device 306, and a central processing unit 308. Herein, the central processing unit 308 is communicably coupled with each of the three devices 304a-c and the observer device 306.

As shown, the device 304a comprises at least one first audio sensor (for example, depicted as a first audio sensor 310a), a first spatial orientation sensor 310b, and a first location sensor 310c. Similarly, the device 304b comprises at least one first audio sensor (for example, depicted as a first audio sensor 312a, a first spatial orientation sensor 312b, and a first location sensor 312c. Similarly, the device 304c comprises at least one first audio sensor (for example, depicted as a first audio sensor 314a), a first spatial orientation sensor 314b, and a first location sensor 314c. Herein, the central processing unit 308 is configured to receive, from the device 304a, a first spatial audio capture data from the first audio sensor 310a, a first pose data from the first spatial orientation sensor 310b, and a first location data from the first location sensor 310c, wherein the first spatial audio capture data, the first pose data and the first location data are with respect to the given space 302. Simultaneously, the central processing unit 308 is configured to receive, from the device 304b, a first spatial audio capture data from the first audio sensor 312a, a first pose data from the first spatial orientation sensor 312b, and a first location data from the first location sensor 312c, wherein the first spatial audio capture data, the first pose data and the first location data are with respect to the given space 302. Simultaneously, the central processing unit 308 is configured to receive, from the device 304c, a first spatial audio capture data from the first audio sensor 314a, a first pose data from the first spatial orientation sensor 314b, and a first location data from the first location sensor 314c, wherein the first spatial audio capture data, the first pose data and the first location data are with respect to the given space 302.

Further, the central processing unit 308 is configured to receive, from the observer device 306, a second pose data from a second spatial orientation sensor 316a, and a second location data from a second location sensor 316b, wherein the second pose data and the second location data are with respect to a virtual space 318 that corresponds to the given space 302. In this regard, the central processing unit 308 is configured to process the first spatial audio capture data to correct and align said first spatial audio capture data to generate a processed first spatial audio capture data, based on the first pose data and the first location data. Further, the central processing unit 308 is configured to generate an observer-specific audio data based on the processed first spatial audio capture data, the second location data, and the second pose data; and stream at least the observer-specific audio data to the observer device 306.

Optionally, the system further comprises any one: at least one second camera (for example, depicted as second cameras 320a, and 320b), at least one second audio sensor (not shown for the sake of clarity), arranged in the given space 302, wherein the second cameras 320a-b and the second audio sensors are stationary, wherein the at least one second camera (for example, for the sake of clarity a second camera 320a is shown), is communicably coupled with the central processing unit 308. Optionally, there is shown at least one sound source (for example, depicted as a sound source 322a, and a sound source 322b) arranged in the given space 302. Optionally, sound waves produced from the sound sources 322a-b are shown (i.e., shown by a dotted arrow line 324) within the given space 302.

FIG. 3 is merely an example, which should not unduly limit the scope of the claims herein. A person skilled in the art will recognize many variations, alternatives, and modifications of embodiments of the present disclosure.

1. A system for capturing and rendering spatial audio data of a given space, the system comprising:
at least one device that is arranged within the given space, the at least one device comprising:
at least one first audio sensor;
a first spatial orientation sensor; and
a first location sensor;
an observer device comprising:
a second spatial orientation sensor; and
a second location sensor; and
a central processing unit communicably coupled with the at least one device and the observer device, the central processing unit being configured to:
receive, from the at least one device, a first spatial audio capture data from the at least one first audio sensor, a first pose data from the first spatial orientation sensor, and a first location data from the first location sensor, wherein the first spatial audio capture data, the first pose data and the first location data are with respect to the given space;
receive, from the observer device, a second pose data from the second spatial orientation sensor, and a second location data from the second location sensor, wherein the second pose data and the second location data are with respect to a virtual space that corresponds to the given space;
process the first spatial audio capture data to correct and align said first spatial audio capture data to generate a processed first spatial audio capture data, based on the first pose data and the first location data;
generate an observer-specific audio data based on the processed first spatial audio capture data, the second location data, and the second pose data; and
stream at least the observer-specific audio data to the observer device.

2. The system of claim 1, wherein the at least one device comprises at least two devices, when processing the first spatial audio capture data to correct and align said first spatial audio capture data, the central processing unit is further configured to:
receive first spatial audio capture data from the at least one audio sensor of each of the at least one two devices; and
perform audio stitching between each first spatial audio capture data received from the at least one audio sensor of each the at least one two devices.

3. The system of claim 1, wherein the at least one device comprises at least two devices that are arranged at a first location and a second location, respectively, within the given space, when processing the first spatial audio capture data to correct and align said first spatial audio capture data, the central processing unit is further configured to:
apply interpolation to generate a first audio data for an area between the first location and the second location;
apply extrapolation to generate a second audio data for an area lying outside a predefined threshold range of the first location and/or the second location.

4. The system of claim 1, wherein the observer device further comprises at least one processor that is configured to:
receive the observer-specific audio data;
process the observer-specific audio data to render the observer-specific audio data in a binaural format for spatial playback to a user associated with the observer device.

5. The system of claim 1, the at least one device further comprising at least one first camera, wherein the central processing unit is further configured to:
receive, from the at least one device, at least one first image with respect to the given space, from the at least one first camera;
generate a photogrammetric model, based on the at least one first image data;
render a viewpoint image for the observer device, based on the photogrammetric model, the second location data, and the second pose data; and
stream the viewpoint image corresponding to the observer-specific audio data, to the observer device.

6. The system of claim 5, wherein the at least one first camera is implemented as at least one visible light camera.

7. The system of claim 6, wherein the at least one first camera is implemented as a combination of the at least one visible light camera and at least one depth camera.

8. The system of claim 7, wherein when the at least one first camera is implemented as the combination of the at least one visible light camera and the at least one depth camera, the central processing unit is further configured to:
receive depth data from the at least one depth camera for each of the at least one first image;
process the depth data corresponding to the at least one first image for temporal and spatial alignment; and
fuse with or enhance the depth data with the photogrammetric model.

9. The system of claim 8, further comprising a video-see-through (VST) camera, wherein the central processing unit is further configured to:
capture, using the VST camera, at least one VST image data of the given space from a given pose of the at least one device;
determine a temporal relationship between the at least one VST image data and the first spatial audio capture data;
adjust a timing of at least one of: the at least one VST image data, the first spatial audio capture data to at least one of: synchronise, time correct the at least one VST image data and the first spatial audio capture data with each other, based on the temporal relationship; and
outputting the at least one of the: at least one VST image data, the first spatial audio capture data, that has been adjusted, to the observer device.

10. The system of claim 1, wherein a given device is any one of:
stationary at a predefined position in the given space, non-stationary within the given space.

11. The system of claim 1, the at least one device comprises at least one of: a head-mounted display (HMD) device, an extended-reality (XR) headset, a virtual reality headset, an augmented reality headset, a pair of XR glasses, a pair of smart Glasses, a tablet, a smart phone, a non-HMD device.

12. The system of claim 1, wherein the observer device comprises at least one of: a head-mounted display (HMD) device, an extended-reality (XR) headset, a virtual reality headset, an augmented reality headset, a pair of XR glasses, a non-HMD device.

13. The system of claim 1, wherein the at least one first audio sensor comprises at least one of: a microphone array, an acoustic camera.

14. The system of claim 1, wherein the system further comprises a data repository communicably coupled to the central processing unit, wherein the data repository is configured to store thereat the second pose data and the second location data of the observer device.

15. The system of claim 5, wherein prior to rendering the viewpoint image for the observer device, the central processing unit is further configured to generate a three-dimensional (3D) representation, based on the at least one first image.

16. The system of claim 5, further comprising any one: at least one second camera, at least one second audio sensor, arranged in the given space, wherein the at least one second camera and the at least one second audio sensor are stationary, wherein the at least one: the at least one second camera, the at least one second audio sensor, are communicably coupled with the central processing unit,
wherein the central processing unit is further configured to:
receive at least one second image from the at least one second camera, a second spatial audio capture data from the at least one second audio sensor; and
update the at least one first image and the first spatial audio capture data using the at least one second image and the second spatial audio capture data, respectively.

17. A method for capturing and rendering spatial audio data of a given space, the method comprising:
receiving, from at least one device, a first spatial audio capture data from at least one first audio sensor, a first pose data from a first spatial orientation sensor, and a first location data from a first location sensor, wherein the first spatial audio capture data, the first pose data and the first location data are with respect to the given space;
receiving, from observer device, a second pose data from a second spatial orientation sensor, and a second location data from a second location sensor, wherein the second pose data and the second location data are with respect to a virtual space that corresponds to the given space;
processing the first spatial audio capture data to correct and align said first spatial audio capture data to generate a processed first spatial audio capture data, based on the first pose data and the first location data;
generating an observer-specific audio data based on the processed first spatial audio capture data, the second location data, and the second pose data; and
streaming at least the observer-specific audio data to the observer device.
